(19) United States
(12) Patent Application Publication
(10) Pub. No.: US 2014/0283095 A1
(43) Pub. Date: Sep. 18, 2014

(54) COLLABORATIVE PUBLISHING WITHIN A SOCIAL NETWORK

(71) Applicants: Philip John MacGregor, Chicago, IL (US); Keenan Pridmore, Chicago, IL (US); Debra Bednar, New York, NY (US)

(72) Inventors: Philip John MacGregor, Chicago, IL (US); Keenan Pridmore, Chicago, IL (US); Debra Bednar, New York, NY (US)

(21) Appl. No.: 13/842,063

(22) Filed: Mar. 15, 2013

(51) Int. Cl. G06F 21/62

(52) U.S. Cl. CPC G06F 21/6218
USPC 726/26

(57) ABSTRACT

Exemplary methods, apparatuses, and systems select a plurality of entities within a social network. Content published by each entity to the social network is received by a plurality of users of the social network that follow the plurality of entities within the social network. One or more of the plurality of entities is selected based upon a characteristic of the plurality of following users. Permission is received from the plurality of entities to publish content to the social network on behalf of each entity. Utilizing the permission, content within a single theme is published to the social network on behalf of each of the plurality of entities, wherein the content within the single theme is published on behalf of each of the plurality of entities contemporaneously with each of the others of the plurality of entities.

### FIELD

The various embodiments described herein relate to utilizing a plurality of entities to collaboratively publish content within a social network. In particular, the embodiments relate to utilizing entity accounts with large numbers of fans or followers within a social network to collaboratively and contemporaneously publish content within a single theme to maximize the number of users of the social network that view content within the single theme.

### BACKGROUND

A social networking system allows users to designate other users or entities as connections (or otherwise follow, become a fan of, connect to, or form relationships with, other users or entities), contribute and interact with their connections, post media or commentary, use applications, join groups, list and confirm attendance at events, invite connections, and perform other tasks that facilitate social interaction. External applications also use the services of a social networking system to allow authenticated users to incorporate some of the above social interactions with use of the external applications.

### SUMMARY OF THE DESCRIPTION

Exemplary methods, apparatuses, and systems select a plurality of entities within a social network. Content published by each entity to the social network is received by a plurality of users of the social network that follow the plurality of entities within the social network. One or more of the plurality of entities is selected based upon a characteristic of the plurality of following users. Permission is received from the plurality of entities to publish content to the social network on behalf of each entity. Utilizing the permission, content within a single theme is published to the social network on behalf of each of the plurality of entities, wherein the content within the single theme is published on behalf of each of the plurality of entities contemporaneously with each of the others of the plurality of entities.

Other features and advantages will be apparent from the accompanying drawings and from the detailed description.

### BRIEF DESCRIPTION OF THE DRAWINGS

The present invention is illustrated by way of example and not limitation in the figures of the accompanying drawings, in which like references indicate similar elements, and in which:

FIG. 1 is a flow chart illustrating an exemplary method of collaborative publishing;

FIG. 2 illustrates an exemplary graphical user interface displaying content published on behalf of an entity;

FIG. 3 illustrates two exemplary graphical user interfaces, each displaying content contemporaneously published on behalf of a different entity within a single theme;

FIG. 4 is an exemplary social graph within the social network utilized in collaborative publishing;

FIG. 5 illustrates, in block diagram form, an exemplary social network; and

FIG. 6 illustrates, in block diagram form, an exemplary processing system to implement an embodiment of collaborative publishing.

### DETAILED DESCRIPTION

Embodiments described herein perform collaborative publishing within a social network. In particular, multiple entities, each with large numbers of followers within the social network, or followers within a particular demographic, are selected. The entities permit content to be published within a single theme on their behalf, e.g., providing a variety of viewpoints all promoting a single product. The contemporaneous publication of content within the single theme through multiple entities reaches a greater number of users than, e.g., a company might reach by promoting the product only through its own social networking account.

FIG. 1 is a flow chart illustrating an exemplary method 100 of collaborative publishing. At block 105, a processing system optionally selects a trigger event for the collaborative publications. For example, the collaborative publishing may be coordinated around the release of a new product, a predetermined day and time, a sale/discount on a product, a holiday, the beginning of a season, a time commonly associated with the purchase of a product, the airing of a major advertisement (e.g., a commercial during a major sporting event), etc.

In one embodiment, the processing system determines that an upcoming event is candidate trigger event related to a single theme. For example, the processing system determines that Valentine's Day, celebrated on February 14^{th}, is coming up in a month, a few weeks, or another threshold of time. The processing system may recognize a particular day prior to Valentine's Day as a candidate trigger event for a theme, e.g., advertising or otherwise promoting jewelry as gifts for Valentine's Day. In response to the determination, the processing system recommends the candidate trigger event to an entity related to the single theme, e.g., a jeweler. For example, the processing system may generate a private message or email to the jeweler alerting the jeweler of the opportunity to utilize collaborative publishing to promote their Valentine's Day sales. In response to the recommendation, the processing system receives selection of the candidate event to have the candidate event serve as the trigger event for collaborative publishing around the theme. In one embodiment, the advertising/promoted (e.g., the jeweler) entity may edit the recommended or selected trigger date.

In an alternate embodiment, a person representing the social network and/or a person representing the entity utilizing collaborative publishing manually selects the trigger event/time and said selection is received by the processing system.

At block 110, the processing system selects a plurality of entities within the social network to participate in the collaborative publishing. A social networking service enables an entity or user to broadcast to a set of followers, fans, or other connections within the social network. In particular, content published by each selected entity to the social network is received by a plurality of users of the social network that follow the respective entities within the social network. Broadcasts include publications of text, images, video, and/or actions with respect to objects. As used herein, an object is a noun within the publication and represents, e.g., an entity, item, or location. As used herein, an action is a verb within the publication that corresponds to an object. Exemplary objects include, but are not limited to, articles, blogs, books, profiles, movies, television shows/episodes, videos, images, websites, cities, individuals, businesses, organizations, groups, and public figures. Exemplary actions include, but are not limited to, like, read, listen, watch, view, friend, follow, subscribe, share, republish, and comment. Exemplary publications will be described further with reference to FIGS. 2 and 3.

In one embodiment, one or more of the plurality of entities is selected based upon a characteristic of the plurality of following users (individually or collectively) that follow one or more of the entities. In one embodiment, the characteristic includes a minimum threshold of followers. For example, candidate entities may be selected based upon having a million or more followers.

In one embodiment, an entity is selected based upon estimated social gravity or influence. For example, an entity's social gravity or influence is estimated as described in U.S. patent application Ser. No. 13/688,015, which is incorporated by reference herein in its entirety.

In one embodiment, an entity is selected based upon a characteristic of the entity. For example, an entity may be selected based upon the entity's demographic information. In another embodiment, the characteristic includes demographic information about the followers of an entity. Exemplary demographic information includes gender, age, hometown, current location, school attended, membership in an organization, religious affiliation, level of education, relationship status, occupation, and information about connections within the social network. Additional exemplary demographic information includes the user's past activity within the social network. For example, the demographic information may include the user previously broadcasting that she likes an entity or another object, attends an event, or takes another action with respect to an object within the social network.

In one embodiment, users are able to add demographic information to user profiles. In one embodiment, for demographic information that has not been entered by a user, a social network application generates an estimate based upon the user's actions, connections, and/or actions of connections. Users may select privacy settings to control if/what demographic information is shared, published, and/or may be used for selection of entities as described herein.

In one embodiment, the selection one or more of the plurality of entities includes the processing system receiving a user characteristic related to the single theme, querying a database to determine entities followed by users that meet the user characteristic, and receiving a list of candidate entities with following users that meet the user characteristic related to the single theme in response to the database query. For example, the social networking service may include a recommendation service that utilizes the social networking platform to rank objects based upon user actions within the social network and corresponding user demographic information and to provide timely, socially relevant, and specifically tailored recommendations based upon the rankings. As users perform actions, e.g., following an entity, connections are made between demographic information related to the acting users and the entities. This history of these user actions creates a ranking of the popularity of entities for various demographic groups, e.g., increasing and optionally decaying corresponding counters. The recommendation service may then receive a query as to the entities with the most followers of one or more demographic categories (individually or combined demographic categories).

In another embodiment, an entity is selected based upon a matching characteristic between the entity and another entity. For example, an entity is selected if it is determined that the entity has a matching characteristic with another selected entity or the entity utilizing the collaborative publishing.

In yet another embodiment, an entity is selected manually, e.g., by an entity utilizing collaborative publishing without the use of automatically generated candidate entities. For example, the entity utilizing collaborative publishing may have an existing relationship, e.g., a sponsorship or other cooperative business relationship, with another entity and select that entity based upon the existing relationship. In one embodiment, the recommendation service receives a selected entity (manually or automatically) and returns demographic information regarding followers of the entity, similar or matching entities, or a determined social gravity of the entity.

At block 115, the processing system receives permission from each selected entity to publish content on behalf of each selected entity. This permission grants the processing system the ability to control the timing of each publication, whether the collaborative publishing be manually executed or executed in response to a trigger event. In one embodiment, each entity submits the content to be published along with permission to publish the submitted content on its behalf.

At block 120, the processing system contemporaneously publishes content within a single theme on behalf of each entity. Exemplary content of the collaborative publications is discussed further with reference to FIGS. 2 and 3. As used herein, contemporaneously publishing content refers to publishing the content on behalf of each entity at or around the same time. For example, a publication on behalf of one entity may be published within seconds, minutes, or an hour of a publication on behalf of another entity and be considered to be contemporaneously published with the other publication. In one embodiment, the publication of content on behalf of the plurality of entities is executed in response to a trigger event, e.g., a predetermined date and time, as discussed above.

At block 125, the processing system optionally promotes the published content to a high priority. For example, the social networking platform may display published content to users based upon varying levels of priority. The priority will help determine where the publication is published in relation to other publications received by users (e.g., a position relative to the “top” or first viewed portion of a vertical news feed) or if the publication is received at all by one or more users (e.g., if users filter low priority messages out of their feed of publications). In one embodiment, publications from users/entities the social networking platform determines to be important to or in a close relationship with a given user (e.g., based on user-provided relationship data or a history of interactions between the users/entities) are given a high priority. Similarly, publications from users/entities the social networking platform determines to be less important to or in a more casual relationship with a given user (e.g., based on user-provided relationship data or a history of interactions between the users/entities) are given a lower priority. In one embodiment, a publication on behalf of an entity is promoted to a high priority, without a preexisting importance/closeness of relationship between the entity and social networking users receiving the publication, e.g., in response to the social network receiving payment for increased priority. This optional boost of priority for the collaborative publications increases the likelihood of users viewing the publications within the single theme.

FIG. 2 is an exemplary graphical user interface (GUI) 200 displaying a user's social network news feed including content 205 published on behalf of an entity, Entity_{—}1, and received by a user following Entity_{—}1. For simplicity, the GUI 200 includes a single publication 205 from Entity_{—}1. The news feed in GUI 200, or other form of news feed, however, would often include multiple publications from one or more entities/other users.

In one embodiment, publications include a timestamp or other indication 210 of when the content was published to the social network. The exemplary published content 205 includes text 215 and an image or video 220. The text 215 may be written by or on behalf of the entity as an expression of thought of the entity, describe an action taken by the entity with respect to an object (e.g., as described above), or describe the image or video 220. Following the Valentine's Day example from above, if Entity_{—}1 (e.g., a public persona, corporate entity, etc.) participates in collaborative publishing on behalf of a jeweler, the processing system publishes the content 205 on behalf of Entity_{—}1. The published content 205, as received by the user, includes text 215 promoting the jeweler around the Valentine's Day theme and/or an image 220 of jewelry sold by the jeweler.

The exemplary GUI 200 further includes one or more selectable controls 225 to enable the receiving user (e.g., a user that follows Entity_{—}1) to interact with the published content 205. Interactions with the publication 205 include, e.g., liking the publication 205, commenting on the publication 205, sharing the publication 205, and reading other user's comments on the publication 205. One or more of the interactions may cause the publication 205 to be republished by the interacting user, as will be described further with reference to FIGS. 3 and 4. In one embodiment, user interaction via controls 225 with a publication 205 increases the priority of the publication 205 (e.g., when received by other users as a publication by Entity_{—}1 or as a republication by the interacting user).

FIG. 3 illustrates two exemplary GUI's 305 and 310, each displaying content contemporaneously published on behalf of a different entity within a single theme and as received by a user connected to a user following an entity. As used herein, a user connected to a user following an entity will be referred to as a “friend” of the user following the entity. For example, a friend of User_{—}1 receives a publication 315 describing that User_{—}1 likes Entity_{—}1, or another indication that User_{—}1 follows Entitiy_{—}1, is a fan of Entity_{—}1, etc. Alternatively, the publication 315 may describe that User_{—}1 interacted with Entity_{—}1's publication, e.g., by liking, sharing, or commenting on Entity_{—}1's publication. The publication 315 further includes a republication 325 of content published on behalf of Entity_{—}1. The republication 325 is similar to the publication 205 described above, e.g., including text promoting the jeweler around the Valentine's Day theme and/or an image of jewelry sold by the jeweler.

Similarly, GUI 310 displays a publication 320 received by a friend of User_{—}2 describing that User_{—}2 likes Entity_{—}2 and includes a republication 330 of content published on behalf of Entity_{—}2. As illustrated by the timestamps 335 and 340, republications 325 and 330 are republishing content published on behalf of the entities contemporaneously (in this example, within one minute of one another). The republication 330 is also similar to the publication 205 described above, but may include different text promoting the jeweler around the Valentine's Day theme and/or a different image of jewelry sold by the jeweler. For example, the content of each republication 325 and 330 may, respectively, provide that entity's perspective, testimony, or personalized relation to the theme/promotion.

FIG. 4 is an exemplary social graph 400 within the social network utilized in collaborative publishing. The social graph 400 is a visual illustration of a data structure stored by the social network to determine the connections between entities/users. Each circle represents an entity or user within the social network. Each line illustrates the connection between users/entities. For example, User_{—}1 follows Entity_{—}1 and is friends with Friend_{—}1, Friend_{—}2, and Friend_{—}3.

In one embodiment, the type of connection between users/entities indicates how the social network handles publications by each connected party. For example, User_{—}1 will receive publications from Entity_{—}1 as a result of User_{—}1 following Entity_{—}1. Entity_{—}1, however, will not necessarily receive publications from User_{—}1 without an additional connection. A “following” connection, therefore, is unidirectional. User_{—}1 and Friend_{—}1 are friends, which is a bidirectional connection. Friend_{—}1 receives User_{—}1's publications and User_{—}1 receives Friend_{—}1's publications.

When Entity_{—}1 and Entity_{—}2 participate in collaborative publishing, the followers of the entities receive the contemporaneous publications, including the message of the single theme. For example, User_{—}1, User_{—}3, and User_{—}4 are all following Entity_{—}1 and receive Entity_{—}1's publication (e.g., similar to the publication 205 described above with reference to FIG. 2). User_{—}2, User_{—}5, User_{—}6, and Friend_{—}3 all follow Entity_{—}2 and receive Entity_{—}2's publication (e.g., also similar to the publication 205 described above).

In one embodiment, friends of users that follow Entity_{—}1 and Entity_{—}2 receive republications of the collaborative publications. For example, Friend_{—}1, Friend_{—}2, and Friend_{—}3 are all friends with User_{—}1 and receive a republication of Entity_{—}1's publication (e.g., similar to the publication 315 described above with reference to FIG. 3). Friend_{—}8, Friend_{—}9, and Friend_{—}10 also receive this republication due to respective friendships with User_{—}3 and User_{—}4. Similarly, Friend_{—}4, Friend_{—}5, Friend_{—}6, and Friend_{—}7 are friends with User_{—}2 and receive a republication of Entity_{—}2's publication (e.g., similar to the publication 320 described above with reference to FIG. 3). Friend_{—}11 and Friend_{—}12 also receive this republication due to respective friendships with User_{—}5 and User_{—}6.

Given that Friend_{—}3 follows Entity_{—}2, Friend_{—}3 will receive both the publication from Entity_{—}2 and the republication of Entity_{—}1's publication from User_{—}1. Similarly, given that User_{—}1 is friends with Friend_{—}3, User_{—}1 will receive both the publication from Entity_{—}1 and the republication of Entity_{—}2's publication from Friend_{—}3. In one embodiment, the social network determines that Entity_{—}1's publication (or republication thereof) and Entity_{—}2's publication (or republication thereof) pertain to a single theme and collapses the two publications into a single, concatenated publication. Alternatively, each publication is received separately.

Given that Friend_{—}11 is friends with both User_{—}5 and User_{—}6, Friend_{—}11 receives the republication of Entity_{—}2's publication from both User_{—}5 and User_{—}6. In one embodiment, the social network determines that the two republications of Entity_{—}2's publication include similar content and collapses the two publications into a single publication. For example, the collapsed publication may be similar in appearance to publication 320 described above with reference to FIG. 3, but include a description indicating User_{—}5 and User_{—}6 like Entity_{—}2. Alternatively, each publication is received separately.

FIG. 5 illustrates, in block diagram form, an exemplary social network 500. The exemplary social network 500 includes user devices 505, a social networking system 510, and an external server 515 coupled to one or more networks 520. A user interacts with the social networking system 510 using a user device 505, such as a personal computer or a mobile phone. For example, the user device 505 communicates with the social networking system 510 via an application such as a web browser or native application. Typical interactions between the user device 505 and the social networking system 510 include receiving publications, operations to view profiles of other users of the social networking system 510, contributing and interacting with media items, joining groups, listing and confirming attendance at events, checking in at locations, liking certain pages/posts, creating pages, and performing other tasks that facilitate social interaction, as described herein. Each of these interactions is an exemplary interaction of a user accessing the social networking system 510 as a network service.

The social networking system 510 includes platform storage 525, a recommendation service 530, one or more application programming interfaces (API's) 535, a social graph 540 (e.g., as described with reference to FIG. 4), and one or more platform applications 545. Platform storage 525 stores user preferences/settings, profile data, etc. Exemplary platform applications 530 include the platform for social interactions (e.g., publishing posts, pictures, etc.) as well as social games, messaging services, and any other application that uses the social platform provided by the social networking system 510.

In one embodiment, the method 100 described above is performed by a platform application 545 and/or the recommendation service 530. For example, the recommendation service 530 may recommend an entity based upon demographic information, entity matching, or social gravity, as described herein. Demographic data is received from platform storage 525 and/or the social graph 540, and the rankings of the popularity of entities for various demographic groups are stored in platform storage 525. Alternatively, one or more of the method 100 and/or data is performed/stored external to the social networking system 510, e.g., in the external server 515.

One or more API's 535 enable external applications 550 to work with the social networking system 510. For example, an external application 550 utilizes an API 535 to authenticate a user based upon the user's social networking log in username and password. Additionally, an external application 550 utilizes one or more API's 535 to run the application within the platform application 530, to publish a post to the platform application, to access the user's social network connections in the social graph 540, etc. In one embodiment, the method 100 described above is performed by an external application 550 and data is received from and/or stored in one or more of the external storage 545, platform storage 525, and social graph 540.

FIG. 6 illustrates, in block diagram form, an exemplary processing system 600 to implement collaborative publishing as described herein. Data processing system 600 includes one or more microprocessors 605 and connected system components (e.g., multiple connected chips). Alternatively, the data processing system 600 is a system on a chip.

The data processing system 600 includes memory 610, which is coupled to the microprocessor(s) 605. The memory 610 may be used for storing data, metadata, and programs for execution by the microprocessor(s) 605. The memory 610 may include one or more of volatile and non-volatile memories, such as Random Access Memory (“RAM”), Read Only Memory (“ROM”), a solid state disk (“SSD”), Flash, Phase Change Memory (“PCM”), or other types of data storage. The memory 610 may be internal or distributed memory.

The data processing system 600 also includes an audio input/output subsystem 615 which may include a microphone and/or a speaker for, for example, playing back music or other audio, receiving voice instructions to be executed by the microprocessor(s) 605, playing audio notifications, etc. A display controller and display device 620 provides a visual user interface for the user.

The data processing system 600 also includes one or more input or output (“I/O”) devices and interfaces 625, which are provided to allow a user to provide input to, receive output from, and otherwise transfer data to and from the system. These I/O devices 625 may include a mouse, keypad or a keyboard, a touch panel or a multi-touch input panel, camera, optical scanner, network interface, modem, other known I/O devices or a combination of such I/O devices.

The I/O devices and interfaces 625 may also include a connector for a dock or a connector for a USB interface, FireWire, Thunderbolt, Ethernet, etc. to connect the system 600 with another device, external component, or a network. Exemplary I/O devices and interfaces 625 also include wireless transceivers, such as an IEEE 802.11 transceiver, an infrared transceiver, a Bluetooth transceiver, a wireless cellular telephony transceiver (e.g., 2G, 3G, 4G, etc.), or another wireless protocol to connect the data processing system 600 with another device, external component, or a network and receive stored instructions, data, tokens, etc.

It will be appreciated that one or more buses, may be used to interconnect the various components shown in FIG. 6.

The data processing system 600 is an exemplary representation of one or more of the user's device 505, at least a portion of the social networking system 510, or the external server 515. The data processing system 600 may be a personal computer, tablet-style device, a personal digital assistant (PDA), a cellular telephone with PDA-like functionality, a Wi-Fi based telephone, a handheld computer which includes a cellular telephone, a media player, an entertainment system, or devices which combine aspects or functions of these devices, such as a media player combined with a PDA and a cellular telephone in one device. In other embodiments, the data processing system 600 may be a network computer, server, or an embedded processing device within another device or consumer electronic product. As used herein, the terms computer, device, system, processing system, processing device, and “apparatus comprising a processing device” may be used interchangeably with the data processing system 600 and include the above-listed exemplary embodiments.

It will be appreciated that additional components, not shown, may also be part of the system 600, and, in certain embodiments, fewer components than that shown in FIG. 6 may also be used in a data processing system 600. It will be apparent from this description that aspects of the inventions may be embodied, at least in part, in software. That is, the computer-implemented method 100 may be carried out in a computer system or other data processing system 510/515/600 in response to its processor or processing system 605 executing sequences of instructions contained in a memory, such as memory 610 or other non-transitory machine-readable storage medium. The software may further be transmitted or received over a network (not shown) via a network interface device 625. In various embodiments, hardwired circuitry may be used in combination with the software instructions to implement the present embodiments. Thus, the techniques are not limited to any specific combination of hardware circuitry and software, or to any particular source for the instructions executed by the data processing system 600.

An article of manufacture may be used to store program code providing at least some of the functionality of the embodiments described above. Additionally, an article of manufacture may be used to store program code created using at least some of the functionality of the embodiments described above. An article of manufacture that stores program code may be embodied as, but is not limited to, one or more memories (e.g., one or more flash memories, random access memories—static, dynamic, or other), optical disks, CD-ROMs, DVD-ROMs, EPROMs, EEPROMs, magnetic or optical cards or other type of non-transitory machine-readable media suitable for storing electronic instructions. Additionally, embodiments of the invention may be implemented in, but not limited to, hardware or firmware utilizing an FPGA, ASIC, a processor, a computer, or a computer system including a network. Modules and components of hardware or software implementations can be divided or combined without significantly altering embodiments of the invention.

In the foregoing specification, the invention has been described with reference to specific exemplary embodiments thereof. Various embodiments and aspects of the invention(s) are described with reference to details discussed herein, and the accompanying drawings illustrate the various embodiments. The description above and drawings are illustrative of the invention and are not to be construed as limiting the invention. Numerous specific details are described to provide a thorough understanding of various embodiments of the present invention. However, in certain instances, well-known or conventional details are not described in order to provide a concise discussion of embodiments of the present inventions.

It will be evident that various modifications may be made thereto without departing from the broader spirit and scope of the invention as set forth in the following claims. For example, the methods described herein may be performed with fewer or more features/blocks or the features/blocks may be performed in differing orders. Additionally, the methods described herein may be repeated or performed in parallel with one another or in parallel with different instances of the same or similar methods.

What is claimed is:

1. A computer-implemented method, comprising:
selecting a plurality of entities within a social network, wherein content published by each entity to the social network is received by a plurality of users of the social network that follow the plurality of entities within the social network, and wherein one or more of the plurality of entities is selected based upon a characteristic of the plurality of following users;
receiving permission from the plurality of entities to publish content to the social network on behalf of each entity; and
publishing content within a single theme to the social network on behalf of each of the plurality of entities, wherein the content within the single theme is published on behalf of each of the plurality of entities contemporaneously with each of the others of the plurality of entities.

2. The computer-implemented method of claim 1, wherein the content within the single theme is published on behalf of each of the plurality of entities in response to a trigger event.

3. The computer-implemented method of claim 2, further comprising:
determining an upcoming event to be a candidate trigger event related to the single theme;
recommending the candidate trigger event to an entity related to the single theme; and
receiving, from the entity related to the single theme, selection of the candidate event to have the candidate event serve as the trigger event.

4. The computer-implemented method of claim 1, wherein selecting the plurality of entities comprises:
receiving input indicating a user characteristic related to the single theme;
querying a database to determine entities followed by users that meet the user characteristic; and
receiving a list of candidate entities with following users that meet the user characteristic related to the single theme in response to the database query.

5. The computer-implemented method of claim 1, wherein the characteristic is a common demographic category of the following users.

6. The computer-implemented method of claim 1, wherein the characteristic is a number of following users above a threshold.

7. The computer-implemented method of claim 1, wherein content published to the social network is displayed to users based upon priority, the method further comprising:
promoting the published content within the single theme to a high priority.

8. A non-transitory computer-readable medium storing instructions that, when executed by a processor, cause a processor to perform a method comprising:
selecting a plurality of entities within a social network, wherein content published by each entity to the social network is received by a plurality of users of the social network that follow the plurality of entities within the social network, and wherein one or more of the plurality of entities is selected based upon a characteristic of the plurality of following users;
receiving permission from the plurality of entities to publish content to the social network on behalf of each entity; and
publishing content within a single theme to the social network on behalf of each of the plurality of entities, wherein the content within the single theme is published on behalf of each of the plurality of entities contemporaneously with each of the others of the plurality of entities.

9. The non-transitory computer-readable medium of claim 8, wherein the content within the single theme is published on behalf of each of the plurality of entities in response to a trigger event.

10. The non-transitory computer-readable medium of claim 9, the method further comprising:
determining an upcoming event to be a candidate trigger event related to the single theme;
recommending the candidate trigger event to an entity related to the single theme; and
receiving, from the entity related to the single theme, selection of the candidate event to have the candidate event serve as the trigger event.

11. The non-transitory computer-readable medium of claim 8, wherein selecting the plurality of entities comprises:
receiving input indicating a user characteristic related to the single theme;
querying a database to determine entities followed by users that meet the user characteristic; and
receiving a list of candidate entities with following users that meet the user characteristic related to the single theme in response to the database query.

12. The non-transitory computer-readable medium of claim 8, wherein the characteristic is a common demographic category of the following users.

13. The non-transitory computer-readable medium of claim 8, wherein the characteristic is a number of following users above a threshold.

14. The non-transitory computer-readable medium of claim 8, wherein content published to the social network is displayed to users based upon priority, the method further comprising:
promoting the published content within the single theme to a high priority.

15. An apparatus, comprising:
a processing device, wherein the processing device executes instructions that cause the apparatus to:
select a plurality of entities within a social network, wherein content published by each entity to the social network is received by a plurality of users of the social network that follow the plurality of entities within the social network, and wherein one or more of the plurality of entities is selected based upon a characteristic of the plurality of following users;
receive permission from the plurality of entities to publish content to the social network on behalf of each entity; and
publish content within a single theme to the social network on behalf of each of the plurality of entities, wherein the content within the single theme is published on behalf of each of the plurality of entities contemporaneously with each of the others of the plurality of entities.

16. The apparatus of claim 15, wherein the content within the single theme is published on behalf of each of the plurality of entities in response to a trigger event.

17. The apparatus of claim 16, wherein the processing device executes instructions that cause the apparatus to:
determine an upcoming event to be a candidate trigger event related to the single theme;
recommend the candidate trigger event to an entity related to the single theme; and
receive, from the entity related to the single theme, selection of the candidate event to have the candidate event serve as the trigger event.

18. The apparatus of claim 15, wherein selecting the plurality of entities comprises:
receiving input indicating a user characteristic related to the single theme;
querying a database to determine entities followed by users that meet the user characteristic; and
receiving a list of candidate entities with following users that meet the user characteristic related to the single theme in response to the database query.

19. The apparatus of claim 15, wherein the characteristic is a common demographic category of the following users.

20. The apparatus of claim 15, wherein the characteristic is a number of following users above a threshold.
